(19) United States
(12) Patent Application Publication
(10) Pub. No.: US 2008/0160984 A1
(43) Pub. Date: Jul. 3, 2008

(54) METHOD AND APPARATUS FOR ALTERING MOBILE DEVICE BEHAVIOR BASED ON RFID TAG DISCOVERY

(75) Inventors: Stanley J. Benes, Round Lake Beach, IL (US); Anthony K. Dean, Elgin, IL (US); Lawrence A. Downing, Hoffman Estates, IL (US); Dennis R. Schaeffer, Buffalo Grove, IL (US); Subir Saha, Bangalore (IN); Samir Dilipkumar Saklikar, Bangalore (IN); Ishita Majumdar, Lake Zurich, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/775,372

(22) Filed: Jul. 10, 2007

Related U.S. Application Data
(60) Provisional application No. 60/882,910, filed on Dec. 30, 2006.

(51) Int. Cl. H04M 3/00

(52) U.S. Cl. 455/419

(57) ABSTRACT

A communication system is provided that comprises a Radio Frequency Identification (RFID) network coupled to a service provider network. An RFID reader of the RFID network detects an RFID tag associated with a mobile station when the mobile station is present in, or proximate to, a controlled area. The RFID network routes information associated with the RFID tag to the service provider network and, based on the information received from the RFID network, the service provider network alters a behavior of the mobile station when the mobile station is entering, exiting, or present in the controlled area.

### CROSS-REFERENCE TO RELATED APPLICATIONS

This application claims priority from provisional application Ser. No. 60/882,910, entitled “METHOD AND APPARATUS FOR ALTERING MOBILE DEVICE BEHAVIOR BASED ON RFID TAG DISCOVERY,” filed Dec. 30, 2006, and is related to U.S. application Ser. No. 11/299,146, attorney docket no. CS25805RA, which applications are commonly owned and incorporated herein by reference in their entirety.

### FIELD OF THE INVENTION

The present invention relates generally to wireless communication systems, and, in particular, to utilizing Radio Frequency Identification (RFID) tags to alter the behavior of a mobile device operating in a wireless communication system.

### BACKGROUND OF THE INVENTION

With the wireless communication devices of today, communication has become ubiquitous. Wireless communication can occur anytime and anywhere. In addition, the feature rich cellular telephones of today offer much more than a mere voice connection, for example, including digital cameras and web browsing tools. However, there are times when use of a cellular telephone may be inappropriate. For example, use of cellular telephones has been banned in hospitals, on airplanes, and in many public schools and use of a cellular telephone in a theater during a movie or a play can be very disruptive to other theatergoers. By way of another example, many locker rooms have banned use of cellular telephones and it may further be desirable to control use of a cellular telephone in a theater, museum, art gallery, or workplace in order to prevent inappropriate use of the digital camera and/or a voice recorder.

Indiscriminately banning all use of cellular telephones in particular environments may amount to excessive regulation. For example, banning all use of a cellular telephone in a locker room, theater, museum, art gallery, or workplace in order to prevent inappropriate use of the digital camera or voice recorder may result in a banning of a legitimate use of the telephone for an incoming or outgoing voice call. And banning use of a cellular telephone in a public school prevents use of the telephone for an emergency call. Thus the indiscriminate banning of all possible services offered by cellular telephones may decrease the overall safety advantages provided by a cellular telephone and may limit service provider revenues with respect to legitimate use of the telephones in the banned use areas. Furthermore, it is hard, if not impossible, to monitor cellular telephone usage and, as a result, such bans typically are voluntary and difficult to enforce.

Therefore a need exists for a method of enabling and disabling features of a cellular telephone by a network and controlling, by the network, when and where particular services may be provided to the cellular telephone.

### BRIEF DESCRIPTION OF THE DRAWINGS

FIG. 1 is a block diagram of a wireless communication system in accordance with an embodiment of the present invention.

FIG. 2 is a block diagram of a mobile station of FIG. 1 in accordance with an embodiment of the present invention.

FIG. 3 is a block diagram of a Radio Frequency Identification (RFID) tag reader of FIG. 1 in accordance with an embodiment of the present invention.

FIG. 4 is a block diagram of an RFID/service provider database of FIG. 1 in accordance with an embodiment of the present invention.

FIG. 5 is a logic flow diagram of an RFID-based alteration of a behavior of a mobile station by the communication system of FIG. 1 in accordance with an embodiment of the present invention.

FIG. 6 is a signal flow diagram illustrating an exemplary RFID-based alteration of a behavior of a mobile station by the communication system of FIG. 1 in accordance with an embodiment of the present invention.

FIG. 7 is a signal flow diagram illustrating an exemplary RFID-based alteration of a behavior of a mobile station by the communication system of FIG. 1 in accordance with another embodiment of the present invention.

FIG. 8 is a block diagram illustrating a detection of a direction of movement and an alteration of a behavior of a mobile station by the communication system of FIG. 1 in accordance with another embodiment of the present invention.

FIG. 9 is a block diagram illustrating a detection of a direction of movement and an alteration of a behavior of a mobile station by the communication system of FIG. 1 in accordance with another embodiment of the present invention.

FIG. 10 is a block diagram illustrating a detection of a mobile station and an alteration of a behavior of the mobile station by the communication system of FIG. 1 in accordance with another embodiment of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method of enabling and disabling features of a cellular telephone by a network and controlling, by the network, when and where particular services may be provided to the cellular telephone, a communication system is provided that comprises a Radio Frequency Identification (RFID) network coupled to a service provider network. An RFID reader of the RFID network detects an RFID tag associated with a mobile station when the mobile station is present in, or proximate to, a controlled area. The RFID network routes information associated with the RFID tag to the service provider network and, based on the information received from the RFID network, the service provider network alters, that is, enables, disables, or otherwise modifies, a behavior of the mobile station, such as a service provided to the mobile station or a function of the mobile station, when the mobile station is entering, exiting, or present in the controlled area.

Generally, an embodiment of the present invention encompasses a method for altering a behavior of a mobile station comprising detecting a Radio Frequency Identification (RFID) tag associated with the mobile station and altering a behavior of the mobile station based on the detection of the RFID tag.

Another embodiment of the present invention encompasses a wireless communication system comprising an RFID network that detects an RFID tag associated with a mobile station and a service provider network coupled to the RFID network that alters a behavior of the mobile station based on the detection of the RFID tag by the RFID network.

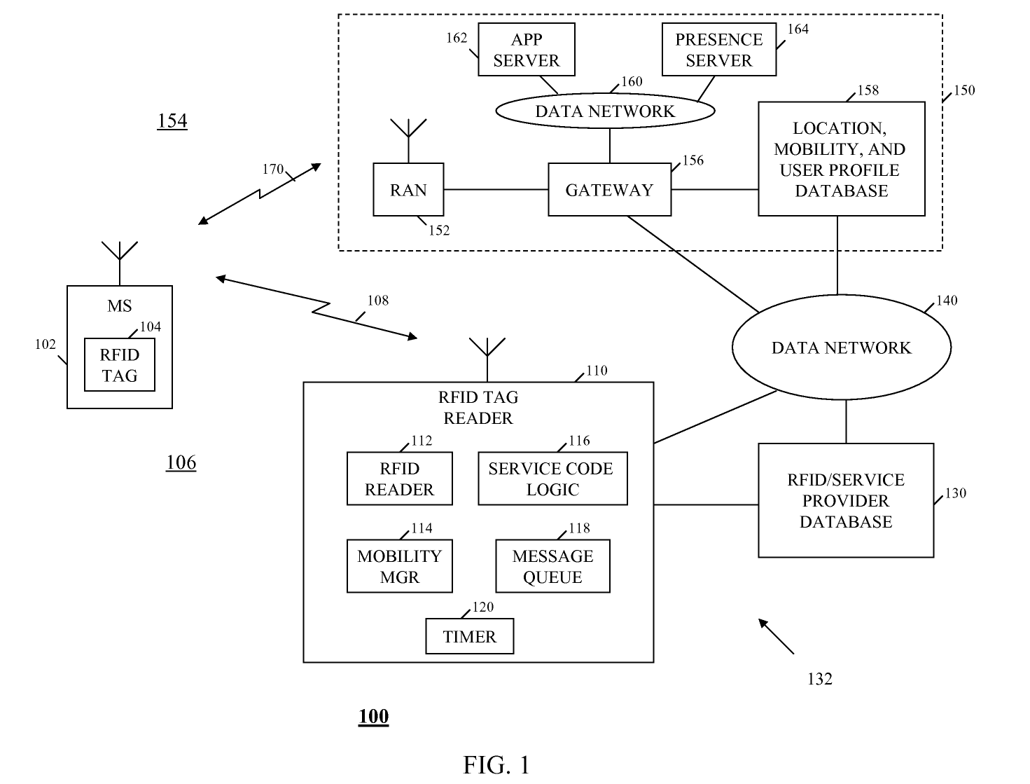

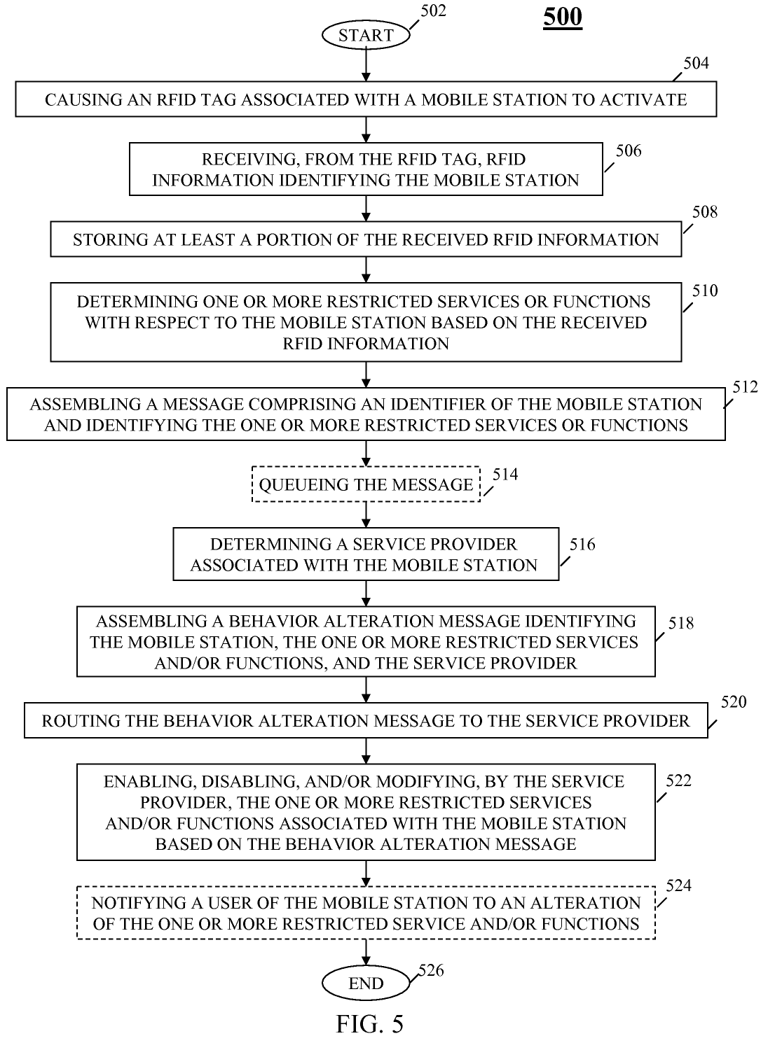

The present invention may be more fully described with reference to FIGS. 1-10. FIG. 1 is a block diagram of a wireless communication system 100 in accordance with an embodiment of the present invention. Communication system 100 comprises a mobile station (MS) 102 that includes a Radio Frequency Identification (RFID) tag 104. MS 102 may be any type of portable wireless device. For instance, MS 102 may be a cellular telephone, a radiotelephone, a pager, or a Personal Digital Assistant (PDA), personal computer (PC), or laptop computer equipped for wireless communications. Other examples of mobile stations are possible.

RFID tag 104 includes a transponder and an associated memory, such as a digital memory chip, that may be read and written to. The memory associated with RFID tag 104 maintains RFID information that includes one or more of the following: an identifier of the associated MS, that is, MS 102, such as an electronic serial number (ESN), an identifier of a service provider whose services are subscribed to by a user of the MS, such as a routing address, for example, an IP (Internet Protocol) address, associated with the service provider, services subscribed to and/or supported by the MS, a routing address assigned to the MS, routing addresses of one or more ‘buddies’ of a user of the MS or of participants currently engaged in a communication session with the MS, a routing address of a presence server, presence information, such as states of presence information elements, associated with MS 102 or of any other Presentity being watched by, or watching, the MS or a time of a most recent presence update, a routing address of an application server, and most recent updates of any information provided to the application server, such as a most recent power level of a battery of the MS.

RFID tag 104 may be either a passive tag or an active tag. As is known in the art, passive RFID tags have no internal power supply. An electrical current induced in an antenna of the MS by an incoming radio frequency (RF) signal provides just enough power for an integrated circuit (IC), typically a complementary metal-oxide-semiconductor (CMOS) IC, in the tag to power up and transmit a response. Unlike passive RFID tags, active RFID tags have their own internal power source which is used to power any ICs that generate the response.

Communication system 100 further includes an RFID tag reader 110 that is associated with an RFID coverage area 106. RFID coverage area 106 is associated with, for example, is included in or adjacent to, a geographic area in which communication system 100 wishes to alter a behavior of MS 102, which geographic area is herein referred to as a “controlled area.” RFID tag reader 110 includes at least one RFID reader 112, a mobility manager 114, service code logic 116, a message queue 118, and a timer 120. Mobility manager 114 stores an identifier associated with each MS detected by RFID reader 112 and further determines and stores a location of such an MS, such as an identity of one or more RFID readers that have detected an RFID tag associated with the MS, and/or a direction of movement of the MS. Service code logic 116 maintains information concerning one or more restricted services and/or functions, that is, one or more services and/or functions that may be enabled, disabled, or otherwise modified when an MS is detected in RFID coverage area 106, which information may include a service code corresponding to each such service and/or function. Service code logic 116 may individually maintain information concerning one or more restricted services and/or functions in association with each MS and/or the service code logic may maintain a general listing of one or more restricted services and/or functions that may be applied to any MS in RFID coverage area 106. Message queue 118 maintains a queue of messages generated by RFID tag reader 110 for conveyance to an RFID/service provider database 130.

RFID reader 112 comprises a transponder (not shown) and a decoder (not shown). The transponder emits an electromagnetic activation signal for activating RFID tag 104 and further is capable of transmitting data to the tag via an RFID air interface 108. The decoder decodes signals received from RFID tag 104 via the RFID air interface. RFID reader 112 may further comprise a memory device (not shown) that maintains an identifier associated with the RFID reader. When MS 102, and in particular RFID tag 104, enters RFID coverage area 106, the MS is exposed to an electromagnetic zone generated by RFID tag reader 110, and more particularly by RFID reader 112. The tag detects RFID reader 112's activation signal and the activation signal causes RFID tag 104 to activate, thereby permitting RFID reader 112 to read and write data to the tag via air interface 108. For example, activation of RFID tag 104 may cause the tag to transmit data stored in the digital memory chip of the tag to RFID reader 112. When the tag transmits the data encoded in the tag's IC, the reader decodes the data and passes the decoded data to a processor associated with the reader. Application software executed by the processor then processes the data from the tag. In addition, when activated, RFID tag 104 is capable of receiving data from RFID reader 110 and processing the received data, including storing the received data in the digital memory chip of the tag.

Communication system 100 further includes an RFID/service provider database 130, which is coupled to RFID tag reader 110, and a service provider network 150. Together, RFID tag reader 110 and RFID/service provider database 130 may be collectively referred to herein as an RFID network 132. RFID network 132 communicates with service provider network 150 via a first data network 140, which data network is coupled to service provider network 150 and is further coupled to one or more of RFID tag reader 110 and RFID/service provider database 130.

Service provider network 150 is a wireless network operated by, under the control of, and/or in association with a service provider whose wireless services are subscribed to by a user of MS 102. The service provider may or may not also operate RFID network 132. Service provider network 150 comprises a gateway 156, for example, a Mobile Switching Center (MSC) in a circuit switched system or some third generation packet-based systems or a Packet Data Support Node (PDSN) in a packet switched system, coupled to each of a radio access network (RAN) 152 and a location, mobility, and user profile database 158, such as a Home Location Register (HLR), a Visited Location Register (VLR), or a Home Subscriber Server (HSS). Service provider network 150 further may comprise an application server 162 and a presence server 164 that are each coupled to gateway 156 via a second data network 160, for example, an IP Multimedia Subsystem (IMS) core network.

Location, mobility, and user profile database 158 maintains mobility information concerning an MS such as MS 102, for example, a location of the MS and routing information for with the MS. Location, mobility, and user profile database 158 further maintains a profile of the MS, which profile includes capabilities of the MS, such as services and functions supported by the MS, services subscribed to by the user of the MS, and an MS-type of the MS, for example, whether the MS is a dual mode or a quad mode handset or the radio frequency bands supported by the MS. RAN 152 provides wireless communication services to mobile stations (MSs), such as MS 102, residing in a coverage area 154 of the RAN. For the purposes of the present invention, it is assumed that RAN coverage area 154 includes RFID coverage area 106. When MS 102 resides in coverage area 154, the RAN provides wireless services to the MS via an air interface 170 that includes a downlink and an uplink. As is known in the art, the downlink may include paging channels, downlink signaling channels, and downlink bearer channels and the uplink may include access channels, uplink signaling channels, and uplink bearer channels.

Service provider network 150 may operate in accordance with any wireless communication standard, as the communication technology employed for the service provider network is not critical to the present invention. For example, network 150 may comprise any of a Frequency Division Multiple Access (FDMA) communication network, a Time Division Multiple Access (TDMA) communication network, a Code Division Multiple Access (CDMA) communication network, a Global System for Mobile Communications (GSM) communication network, any 3GPP (Third Generation Partnership Project) or 3GPP2 (Third Generation Partnership Project 2) communication network, for example, a 3GPP E-UTRA (Evolutionary UMTS Terrestrial Radio Access) communication network or a CDMA (Code Division Multiple Access) 2000 1×EV-DV communication network, a Wireless Local Area Network (WLAN) communication network as described by the IEEE (Institute of Electrical and Electronics Engineers) 802.xx standards, for example, the 802.11, 802.16, or 802.21 standards, or any of multiple proposed ultrawideband (UWB) communication systems.

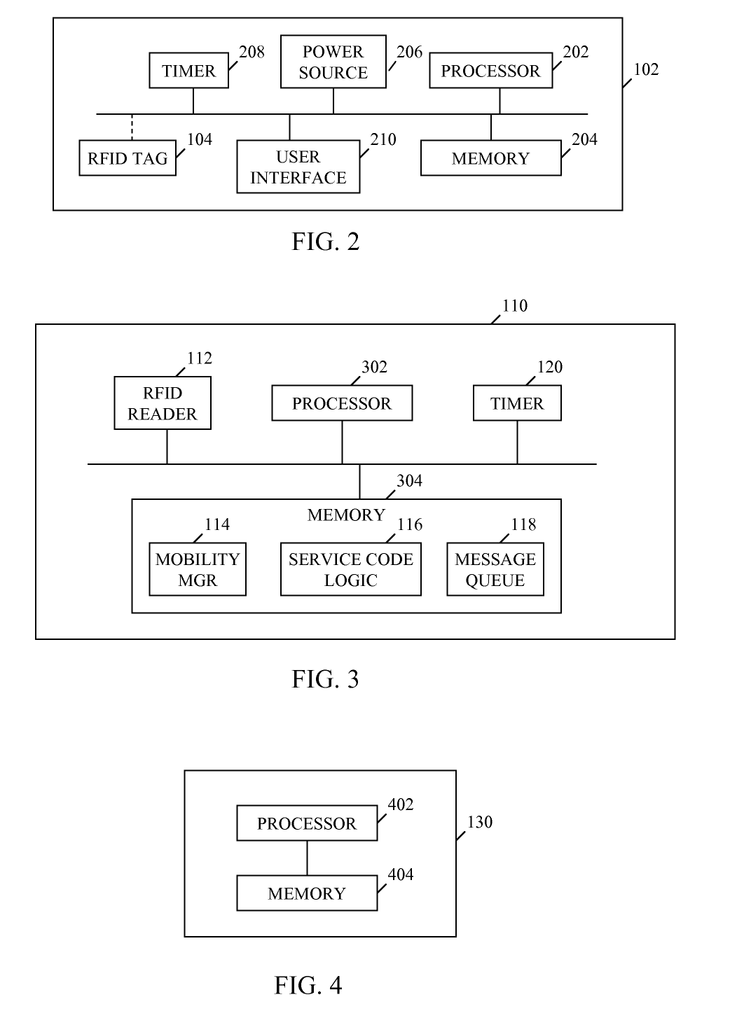

Referring now to FIGS. 2, 3, and 4, block diagrams respectively are provided of MS 102, RFID tag reader 110, and RFID/service provider database 130 in accordance with an embodiment of the present invention. Each of MS 102, RFID tag reader 110, and RFID/service provider database 130 comprises a respective processor 202, 302, and 402, such as one or more microprocessors, microcontrollers, digital signal processors (DSPs), field programmable gate arrays (FPGAs), combinations thereof or such other devices known to those having ordinary skill in the art. Each of MS 102, RFID tag reader 110, and RFID/service provider database 130 further comprises a respective one or more memory devices 204, 304, and 404 coupled to the processor, such as random access memory (RAM), dynamic random access memory (DRAM), and/or read only memory (ROM) or equivalents thereof, that store data and programs that may be executed by the corresponding processor. MS 102 further includes a limited life power source 206 that provides operational power for the MS, for example, a battery, a timer 208, and a user interface 210 that are each coupled to processor 202. User interface 210 provides an apparatus by which a user may interact with MS 102 and input instructions into the MS. For example, user interface 210 may include one or more of a display screen, a key pad, a touch screen, and audio and visual alerts. In addition, MS 102 includes RFID tag 104, which RFID tag may or may not be coupled to processor 202. RFID tag reader 110 further includes RFID reader 112 and timer 120, which RFID reader and timer are each in communication with processor 302 and memory 304.

Processor 402 of RFID/service provider database 130 implements a database manager based on programs maintained in the one or more memory devices 404. Also, each of mobility manager 114, service code logic 116, and message queue 118 of RFID tag reader 110 preferably comprises one or more programs that are maintained in the one or more memory devices 304 of the RFID tag reader and executed by processor 302. Unless otherwise specified herein, the functions described herein as performed by MS 102, RFID tag reader 110, and RFID/service provider database 130 respectively are performed by processors 202, 302, and 402.

Communication system 100 provides for a selective alteration, that is, enablement, disablement, and/or modification, of services provided to, and/or functions of, an MS, such as MS 102, without the intervention of, and possibly further without the knowledge of, a user of the MS. The enablement, disablement, or modification may be location-based and may be MS-specific, that is, a service provider may individually effect each MS in the controlled area only while the MS resides in the controlled area and without impacting mobile stations (MSs) residing outside of the controlled area. For example, communication system 100 allows a service provider to block certain services, such as incoming or outgoing calls, or block certain functions, such as audio alerts or camera use, while allowing other services or functions, such as emergency call capability, when the MS is present in the controlled area. The services and/or functionality enabled, disabled, and/or modified may be individually tailored for each MS and may vary from one controlled area to another. Furthermore, by utilizing RFID tags, such as RFID tag 104, and RFID network 132, communication system 100 allows a service provider to selectively enable, disable, and/or modify the functions of an MS without requiring that the MS be powered on or already have established a communication link in an air interface of the service provider network.

Referring now to FIG. 5, a logic flow diagram 500 is provided that illustrates an RFID-based alteration of a behavior of an MS, such as MS 102, by communication system 100 in accordance with an embodiment of the present invention. Logic flow diagram 500 begins (502) when the MS, that is, MS 102, enters RFID coverage area 106. That is, MS 102 is sufficiently proximate to RFID tag reader 110 that an electromagnetic activation signal transmitted by RFID reader 112 causes (504) an activation of RFID tag 104 of MS 102. As is known in the art, RFID tag 104 self-activates and does not need to draw energy from power source 206 and, therefore, MS 102 need not be powered up when RFID tag 104 activates.

In response to being activated, RFID tag 104 identifies (506) MS 102 to RFID tag reader 110. That is, RFID tag 104 transmits to RFID reader 112, and the RFID reader receives from RFID tag 104, RFID information maintained in the memory associated with the RFID tag, including a unique identifier of MS 102, such as an electronic serial number (ESN) associated with the MS. The RFID information may further include the service provider identifier maintained by the memory associated with the tag. In this way, RFID tag reader 110 is able to detect a presence of MS 102 proximate to, or in, the controlled area. For example, RFID tag reader 110 may be able to detect a presence of MS 102 in, or an entry of the MS into, the controlled area, an exit of the MS from the controlled area, a directional movement of the MS toward the controlled area, a directional movement of the MS away from the controlled area, or a movement of the MS within the controlled area. Based on the detected relationship between MS 102 and the controlled area, service provider network 150 selectively enables, that is, causes to be possible to operate, disables, and/or modifies functionality of the MS and/or services provided to the MS.

In response to receiving the information transmitted by RFID tag 104, mobility manager 114 of RFID tag reader 110 stores (508) at least a portion of the received RFID information. Mobility manager 114 may further store a time stamp in association with the identifier. Further, in response to receiving the RFID information, RFID tag reader 110, and preferably service code logic 116, determines (510) service code(s) associated with one or more services and/or functions that are associated with of MS 102 and that are restricted in controlled area, for example, services and/or functions that are to be disabled and/or modified when the MS is entering or present in the controlled area or services and/or functions whose disablement or modification is to be reversed when the MS is exiting or otherwise no longer present in the controlled area. Accordingly, the services and/or functionality enabled, disabled, or modified in association with the controlled area may be referred to herein as restricted services and/or functionality.

For example, if RFID tag reader 110 is located in or proximate to a movie theater, the restricted services and/or functions may include a disabling of audio ring tones, incoming non-emergency pages of the MS, and/or incoming or outgoing non-emergency calls by the MS when the MS is in the controlled area. By way of another example, if RFID tag reader 110 is located in a locker room or a work place, the restricted services and/or functions may include a disabling of a digital camera or a voice recorder included in the MS when the MS is in the controlled area. A listing of the one or more service codes corresponding to such restricted services or functions may be maintained in the one or more memory devices 304 of RFID tag reader 110, and more particularly in service code logic 116.

RFID tag reader 110, preferably mobility manager 114, then assembles (512) a message comprising the received MS identifier and the one or more service codes corresponding to the restricted services and/or functions, that is, the services and/or functions that are to be enabled, disabled, and/or modified, and conveys (516) the message to RFID/service provider database 130. The message may further include the service provider identifier. When RFID tag reader 110 has multiple messages to convey to RFID/service provider database 130, RFID tag reader 110 may queue (514) each message in message queue 118 before conveying the message to RFID/service provider database 130. For example, when multiple MSs enter the controlled area approximately simultaneously, RFID tag reader 110 may not be able to simultaneously convey a message with respect to each such MS and may need to queue one or more messages. Any algorithm known to one of ordinary skill in the art, for example, first in-first out, may then be applied by RFID tag reader 110 to determine the order in which queued messages are retrieved from queue 118 and conveyed to RFID/service provider database 130.

RFID/service provider database 130 maintains, in the one or more memory devices 404 of the database, various mapping and translation functionality. In one embodiment of the invention, RFID/service provider database 130 maintains a mapping between MS identifiers and service provider identifiers, such as a routing address, for example, an IP address, associated with the service provider whose services are subscribed to by a user of an MS, such as MS 102. Such mapping information may be provided to the operator, or installer, of RFID network 132 by each service provider that subscribes to the services of the RFID network. That is, a service provider who desires that functionality of, or services provided to, subscribing MSs be enabled, disabled, and/or modified when present in an area serviced by RFID network 132 may provide the operator or installer of the RFID network with an identifier of the service provider, a database of MSs subscribing to the services of the service provider, which database includes identifiers of the MSs, and message translation information, that is information concerning a protocol, that is a message format, implemented by the service provider's network, for example, network 150. The protocol may then be used by RFID/service provider database 130 to translate messages received from RFID tag reader 110 to a protocol, or message format, utilized by service provider network 150, and further to translate messages received from service provider network 150 to a protocol utilized by RFID tag reader 110. For example, the service provider may provide service provider service codes that are associated with the restricted features, that is, the services or functionality that the service provider desires to enable, disable, and/or modify when MSs enter into or exit from the controlled area. Thus the operator or installer of RFID network 110 is able to create a mapping of the service codes maintained by RFID tag reader 110 and the corresponding service codes of the subscribing service provider. The mapping is then stored in the one or more memory devices 404 of database 130.

In other embodiments of the present invention, wherein RFID tag 104 maintains an identifier of the service provider subscribed to by the user of the MS and, when activated, provides the identifier to RFID tag reader 110, there may be no need for RFID/service provider database 130 to maintain a mapping between MS identifiers and service provider identifiers, or the RFID/service provider database may maintain a mapping between the service provider identifier maintained in, and provided by, RFID tag 104 and a routing address of the service provider. The latter instance permits a shortened service provider identifier to be maintained by RFID tag 104.

In response to receiving the message from RFID tag reader 110, RFID/service provider database 130 determines (516) the service provider subscribed to by MS 102, that is, the operator of network 150, and routing information for the service provider. RFID/service provider database 130 then assembles (518) an RFID network behavior alteration message that includes the service provider routing information, identifies MS 102, and identifies the one or more restricted services and/or functions associated with MS 102. The RFID network behavior alteration message may further indicate whether the one or more restricted services and/or functions are being enabled, disabled, and/or modified.

RFID/service provider database 130 conveys (520) the RFID network behavior alteration message to service provider network 150, preferably to one or more of gateway 156 and location, mobility, and user profile database 158, via data network 140. In one embodiment, the behavior alteration message may comprise a message, and a message format, agreed to in advance by the service provider and the operator or installer of RFID network 132. In other embodiments of the present invention, RFID/service provider database 130 may include the behavior alteration message in a known inter-system message, for example, by including the message in an IS-41 message.

In response to receiving the RFID network behavior alteration message from RFID network 132, service provider network 150 alters, that is, enables, disables, and/or modifies, (522) the one or more restricted services or functions. For example, when RFID tag reader 110 detects a presence of MS 102 in, or an entry of the MS into, the controlled area, then service provider 150 may disable the one or more restricted services or functions or may modify the one or more restricted services or functions to operate in a limited way. By way of another example, when RFID tag reader 110 detects an exit of the MS from the controlled area, then service provider 150 may enable or otherwise restore the one or more restricted services or functions.

In addition, in response to the alteration of the one or more restricted services or functions, MS 102 may further notify (524) the user of the MS of the enablement, disablement, and/or modification of the one or more restricted services or functions by displaying an alert via user interface 210. For example, service provider network 150 may convey a message to the MS informing of an altered service or function. In response to receiving the message, MS 102 may retrieve from the one or more memory devices 204, and display on a display screen of the user interface, a message or indicator indicating that the one or more restricted services or functions is enabled, disabled, and/or modified. Logic flow 500 then ends (526).

In one embodiment of the present invention, RFID tag reader 110 merely may determine whether the MS is present in the controlled area. In such an embodiment, the RFID network behavior alteration message may merely identify the one or more restricted services and/or functions. Service provider network 150 then may instruct the MS to reverse a current state of the restricted services and/or functions. For example, upon first detecting RFID tag 104, for example, when an employee enters, via a point of ingress and egress, a corporate office, service provider network 150 may disable or otherwise modify the one or more restricted services and/or functions. Upon a second detection of the RFID tag, when the employee exits the corporate office, the services or functionality may be restored.

In another embodiment of the present invention, in order to ensure the restoration of the restricted services and/or functions, a disablement or modification of the restricted services and/or functions may be for a predetermined first time period. In such an event, the service provider network, such as gateway 156 or location, mobility, and user profile database 158, or the MS may include a timer, such as timer 208 of MS 102, that, in response to a disablement or a modification of a restricted service or functionality, counts down the first time period during which the restricted service or functionality remains disabled. Upon expiration of the timer, the disabled service or functionality is restored, if not already restored by a second detection of the RFID tag. By providing for a timer-based disablement or modification of the restricted service or functionality, communication system 100 provides for a restoration of any disabled or modified functionality in the event that the communication system fails to detect an exit of the MS from the controlled area.

In yet another embodiment of the present invention, if RFID tag reader 110 is further able to determine a direction of movement of the MS or a continuous presence of RFID tag 104 in the controlled area, as is described in greater detail below, then the RFID network behavior alteration message may further indicate whether the restricted services and/or functions are to be disabled or otherwise limited (for example, when the MS is entering the controlled area), or to be enabled or otherwise restored (for example, when the MS is exiting or no longer present in the controlled area).

In an embodiment of the present invention wherein the altered behavior involves altering a service provided to the MS 102 by service provider network 150, location, mobility, and user profile database 158 may store an indicator, such as a flag, in the profile of the MS that indicates whether such service is enabled, disabled, or modified for the MS. For example, when the service code is associated with a service provided to MS 102 by service provider network 150, such as a paging service, then service provider network 150 may temporarily alter paging information maintained in association with the MS, for example, blocking provision of a paging service to the MS by storing a ‘blocked service’ indicator, such as a ‘do not page’ indicator, in the profile of MS 102 at location, mobility, and user profile database 158. As a result, when gateway 156 receives a request to page MS 102, the gateway may check with location, mobility, and user profile database 158 and may determine, by reference to the database, that a paging of the MS is blocked (or restored). By blocking paging of MS 102, the MS will not play an alert, such as a ring tone, in response to receiving a page and alerting the user of the MS to a call. As noted above, the blocked services may be tailored to the MS, such as blocking low priority calls but permitting emergency calls. If the behavior modification message instructs a restoration of a provision of a blocked service, then service provider network 150 may resume provision of the service, for example, by deleting the blocked service indicator from the location, mobility, and user profile database.

In an embodiment of the present invention wherein the altered behavior involves altering a functionality of MS 102, for example, a disabling or an enabling of a digital camera or a voice recorder or a playing of an audio alert by the MS, gateway 156 may convey a service provider behavior modification message to MS 102, either presently or upon activation of the MS if the MS is powered down, instructing the MS to enable, disable, and/or modify such functionality. For example, gateway 156 may convey a signaling message, for example, a paging message, that instructs the MS to block execution of, or if already blocked then to resume execution of, such functionality. However, if the need to block the functionality is not immediate, for example, an audio alert may not be executed until a next call is received for the MS, then the gateway may defer conveying the instruction until the need to do so arises. For example, when gateway 156 next receives a request to page MS 102, or receives a request from MS 102 to register or to originate a communication session, gateway 156 may determine, by reference to location, mobility, and user profile database 158, any functions being enabled, disabled, and/or modified with respect to the MS. Gateway 156 then may convey a signaling message, such as a page or a request response, to the MS that includes an instruction to temporarily block execution of, or if already blocked then to resume execution of, such functionality.

Again, the blocked functionality may be tailored to the MS, such as blocking functionality of some MSs detected in coverage area 106 but not of other MSs detected in the coverage area. For example, suppose service provider network 150 is an enterprise network. Location, mobility, and user profile database 158 may then comprise a private database that maintains, for each employee of the enterprise, a user profile that includes an employee identifier, an employee phone number, and rights of each employee, such as services of system 150 and functionality of an MS that the employee is authorized to invoke. Gateway 156 or RAN 152 then may determine, by reference to the user profile in database 158, whether a service or function is to be disabled for the particular user of MS 102.

For example, a manager may have different rights than a lower level employee. Suppose that MS 102 and another MS (not shown) are both detected in coverage area 106. Further suppose that the user of MS 102 is a lower level employee, or is not affiliated with a department associated with coverage area 106, while a user of the another MS is a higher level employee or is employed by the department associated with coverage area 106. The enterprise network may disable a camera or voice recorder of MS 102 when MS 102 is detected in the coverage area. For example, coverage area 106 may be an area where sensitive company documents are maintained or where proprietary manufacturing techniques are practiced. However, the enterprise network may not disable a camera or voice recorder of the another MS even when the another MS is detected in the coverage area.

In other embodiments of the present invention, when gateway 156 is informed of the presence of MS 102 in RFID coverage area 106, as detected by RFID network 132, the gateway may additionally inform one or more of RAN 152, application server 162, and presence server 164 of the presence of MS 102 in coverage area 106, and/or correspondingly in coverage area 154. When RAN 152 or gateway 156 (for example, when the gateway is an MSC) is informed of the presence of MS 102 in coverage area 106/154, the RAN or gateway may update location information associated with MS 102, for example, updating a maintained location of MS 102 to coverage area 154 or to RAN 152, depending upon how a location of an MS is stored.

In one such embodiment, RAN 152, or gateway 156, in response to the detection of RFID tag 104, may update paging information maintained in association with MS 102. For example, the RAN 152 or gateway may update a paging area associated with the MS so that future pages of the MS may be directed to the updated paging area, allowing for a geographically more focused page of the MS. By way of another example, when the RAN or gateway is informed of the presence of MS 102 in coverage area 106/154, the RAN or gateway may adjust the paging interval of the MS. For example, by knowing a current location of the MS via a detection of the MS by RFID network 132, a need for paging an idle MS and for obtaining location updates from the MS is reduced. Therefore, RAN 152 and/or gateway 156 may reduce a paging interval of the MS or may reduce a rate of location update requests. In addition, RAN 152 and/or gateway 156 may further consider a congestion of coverage area 154 or a loading of RAN 152 and may adjust the paging interval based on the congestion or loading, for example, reducing the paging interval of a detected MS when the coverage area is heavily congested or the RAN is heavily loaded.

When presence server 164 is informed of the presence of MS 102 in coverage area 106/154, the presence server may update a presence state of a presence information element associated with MS. In addition, when RFID tag 104 is a writeable tag, presence server 164 may convey a message back to RFID network 132 specifying a current presence state of a presence information element associated with MS or of any other Presentity being watched by, or watching, MS 102 and/or identifying a time of a most recent presence update by the MS. RFID network 132 may then write the presence information to RFID tag 104 via RFID tag reader 110 and RFID interface 108. In turn, when RFID tag 104 is caused to activate by an RFID reader, such as RFID reader 112, the RFID information conveyed by the RFID tag may further include any or all of such presence information stored in the tag and may further include the routing address of presence server 164, so that RFID network 110 may route the received presence information to the presence server. Furthermore, when MS 102 determines that the MS's RFID tag has been scanned, for example, when processor 202 detects an activation of RFID tag 104, the MS may adjust a presence update time period, for example, delaying a performing of future presence updates when MS 102 knows that RFID tag 104 has been, or continues to be, scanned by an RFID network.

When RFID information, such as a most recently reported charge level of the battery of MS 102, is provided to application server 162, the application server may then adjust a provision of services to the MS in order to conserve battery life without requiring the MS to power up. For example, suppose MS 102 intermittently reports a charge level of power source 206 to service provider network 150, and in particular to application server 162, via the uplink of air interface 170. When MS 102 is detected by an RFID network, such as RFID network 132, application server 162 may read, via the detecting RFID network, charge level data associated with power source 206 most recently stored in RFID tag 104 and further may write to the RFID tag, via the detecting RFID network, updated power source 206 charge level data. As a result, when RFID tag 104 is detected by RFID network and, further, a low charge level of power source 206 is detected, application server 162 may act to preserve an energy of power source 206 by, for example, applying resource allocation strategies (for example, adjusting dormancy timers and paging intervals) that minimize power consumption by the MS, controlling a radio configuration to minimize power consumption by the MS, or prohibiting speculative behavior related to the MS, such as speculatively waking up the MS for a call or setting up of a traffic channel in air interface 170 in anticipation of an origination of call by the MS or in anticipation of an acceptance of a call by a target MS.

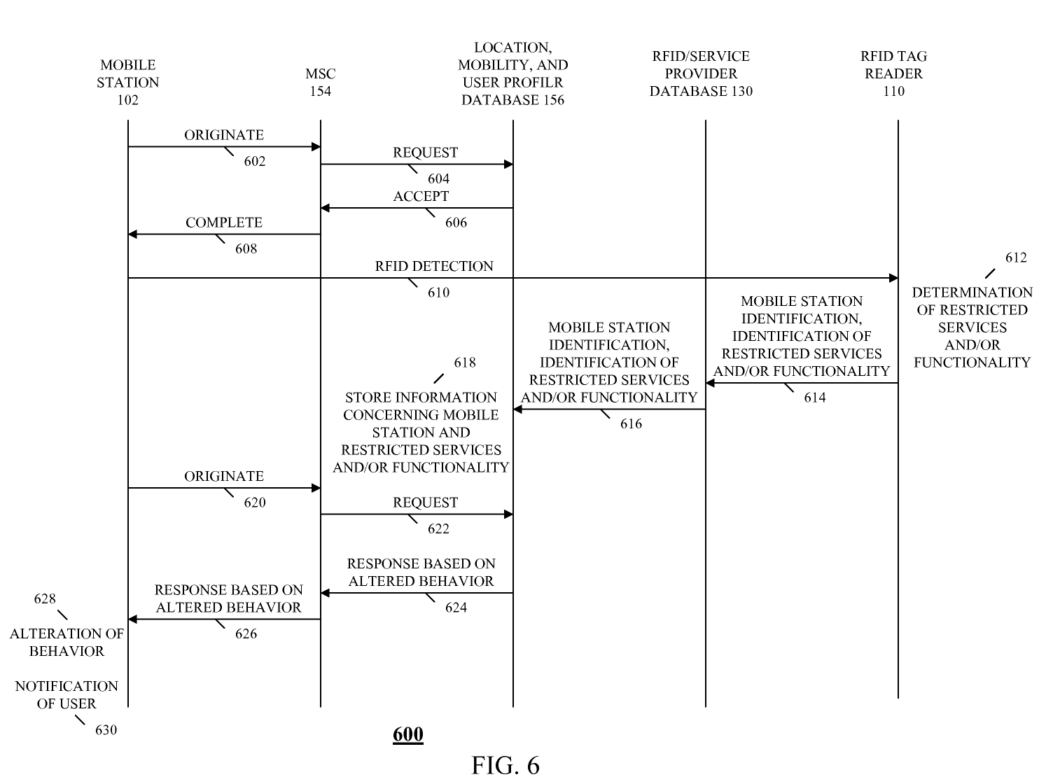

Referring now to FIG. 6, a signal flow diagram 600 is provided that illustrates an exemplary RFID-based alteration of a behavior of a MS, such as MS 102, by communication system 100 in accordance with an embodiment of the present invention. Signal flow diagram 600 begins when the MS, that is, MS 102, originates a first communication session, while outside of the controlled area, by conveying (602) a first origination message to service provider network 150. Service provider network 150 routes the origination message to gateway 156 and the gateway queries (604) location, mobility, and user profile database 158 as to whether the communication session may be set up, for example, queries the location, mobility, and user profile database as to whether a service requested by MS 102 is supported and/or subscribed to by the MS. In response to being informed (606) that the requested service is authorized, gateway 156 then sets up (608) the first communication session with MS 102.

Subsequent to the origination of the first communication session, MS 102 moves to RFID coverage area 106 and RFID tag 104 is activated by RFID tag reader 110. In response to being activated, RFID tag 104 conveys (610) an identifier associated with MS 102, to RFID tag reader 110. RFID tag 104 may further convey service information associated with the MS, such as services and/or functionality subscribed to and/or supported by the MS. RFID tag reader 110 then determines (612) restricted services associated with MS 102, that is, services and/or functionality that is subscribed to and/or supported by the MS and whose operation is restricted when the MS is in the controlled area.

RFID tag reader 110 routes (614) the MS identifier and information concerning the restricted services and/or functionality to RFID/service provider database 130. In response to receiving the MS identifier and service information associated with MS 102, RFID/service provider database 130 assembles, and conveys (616) to location, mobility, and user profile database 158, an RFID network behavior alteration message identifying the MS and informing of any restricted service or functionality, that is, a service or functionality being enabled, disabled, or modified. In response to receiving the behavior alteration message, location, mobility, and user profile database 158 stores (618) information concerning the restricted service or functionality in association with the user profile of MS 102. For example, RFID/service provider database 130 may identify, by associating a flag with or by deleting a flag from, any service or functionality being enabled, disabled, or modified with respect to MS 102.

When MS 102 originates a second communication session by conveying (620) a second origination message to service provider network 150, service provider network 150 routes the call origination message to gateway 156. Gateway queries (622) location, mobility, and user profile database 158 for the location of MS 102 and for the profile of the MS. In response to the query, location, mobility, and user profile database 158 informs (624) gateway 156 of any service or functionality that is currently being enabled, disabled, or modified with respect to MS 102. Gateway 156 then responds (626) to the origination message in a manner appropriate to implement the enablement, disablement, or modification of the restricted service or functionality. For example, when the restricted service or functionality involves a service provided by service provider network 150 to MS 102, then gateway 156 may respond by providing, or blocking provision of, such service, whichever is appropriate. By way of another example, when the restricted service or functionality involves a function of MS 102, such as a digital camera or a voice recorder, then gateway 156 may respond by conveying a service provider behavior modification message to the MS that identifies the MS and instructs the MS to disable, enable, or modify such functionality, whichever is appropriate. In response to receiving the instruction, MS 102 then disables, enables, or modifies (628) such functionality. MS 102 may further notify (630) the user of the MS of the enablement, disablement, and/or modification of the functionality via user interface 210.

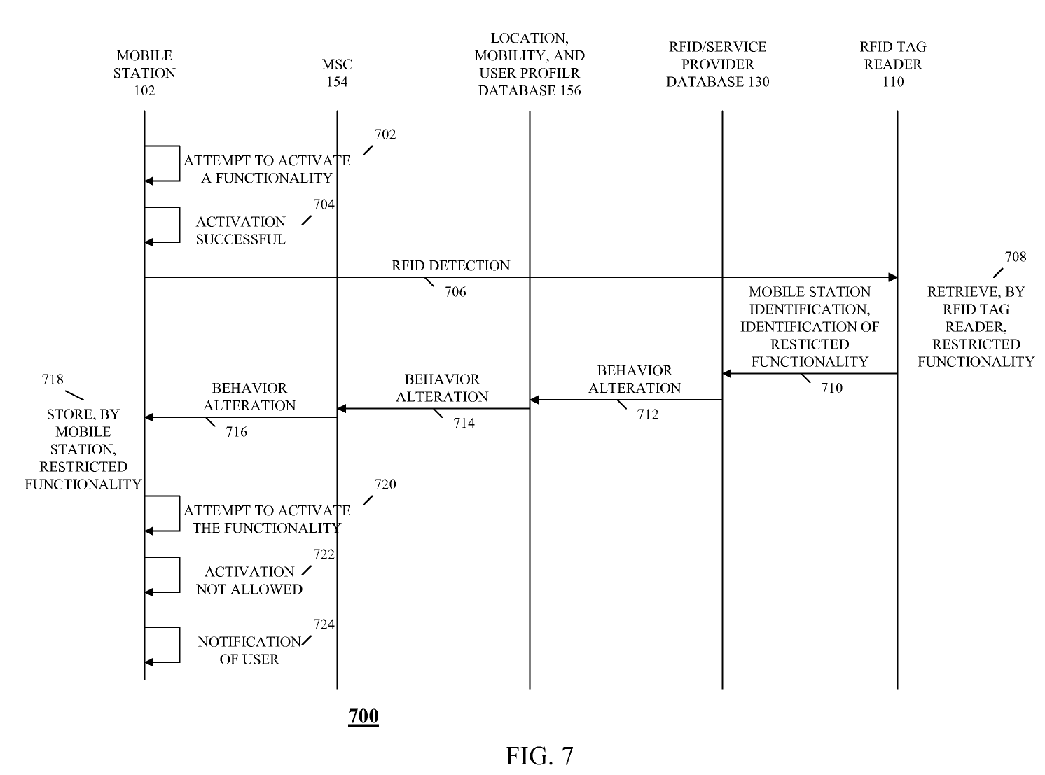

Referring now to FIG. 7, a signal flow diagram 700 is provided that illustrates an exemplary RFID-based alteration of a behavior of a MS, such as MS 102, by communication system 100 in accordance with another embodiment of the present invention. In this embodiment of the present invention, a profile of the MS, that is, MS 102, is maintained in RFID network 110, preferably in the one or more memory devices 304. The profile includes functionality of the MS that is restricted, that is, disabled and/or modified, when the MS is operating in the controlled area associated with RFID tag reader 110. Signal flow diagram 700 begins when the MS, that is, MS 102 is operating outside of the controlled area associated with RFID tag reader 110. MS 102 activates (702) a functionality resident on the MS, which functionality is disabled or otherwise limited in the controlled area. Since MS 102 is outside of the controlled area, the MS successfully activates (704) the functionality.

At some point in time, MS 102 moves to RFID coverage area 106 and RFID tag 104 is activated by RFID tag reader 110. In response to being activated, RFID tag 104 conveys (706) to RFID tag reader 110, and the RFID tag reader receives from RFID tag 104, RFID information including an identifier associated with MS 102. In response to detecting RFID tag 104, RFID tag reader 110 retrieves (708), from the user profile associated with MS 102 and maintained at least one memory device 304, the restricted functionality, that is, the functionality that is to be disabled and/or modified when the MS is present in the controlled area. If the service code(s) associated with this functionality is not maintained in the user's profile, RFID tag reader 110 may further retrieve the corresponding service codes from service code logic 116.

RFID tag reader 110 then routes (710) the MS identifier and identification of the restricted functionality, including the service codes, to RFID/service provider database 130. In response to receiving the MS identifier and the identification of the restricted functionality, RFID/service provider database 130 determines the service provider subscribed to by MS 102, that is, the operator of network 150, and routing information for the service provider. RFID/service provider database 130 may further translate the service codes to service codes recognizable by the service provider if such a translation is needed. RFID/service provider database 130 then assembles an RFID/service provider database behavior alteration message that includes the service provider routing information and that identifies MS 102 and the restricted functionality, including the service codes. RFID/service provider database 130 conveys (712) the RFID/service provider database behavior alteration message to service provider network 150, preferably to one or more of gateway 156 and location, mobility, and user profile database 158, via data network 140. In one embodiment, the behavior alteration message may comprise a message, and a message format, agreed to in advance by the service provider and the operator or installer of RFID network 132. In other embodiments of the present invention, RFID/service provider database 130 may include the behavior alteration message in a known inter-system message, for example, by including the message in an IS-41 message.

In response to receiving the RFID/service provider database behavior alteration message from RFID network 132, location, mobility, and user profile database 158 informs (714) gateway 156 of the functionality that is currently being disabled and/or modified with respect to MS 102. Gateway 156 then assembles and conveys (716) to MS 102, via a serving RAN, that is, RAN 152, a service provider behavior alteration message identifying MS 102 and informing of the restricted functionality. In response to receiving the service provider behavior alteration message, MS 102 stores information concerning the restricted functionality in the one or more memory devices 102 of the MS. When a user of MS 102 subsequently attempts to activate (720) the restricted functionality, the MS blocks or limits the activation of the functionality, whichever is appropriate. MS 102 may further notify (722) the user of the MS of the blocked functionality via user interface 210.

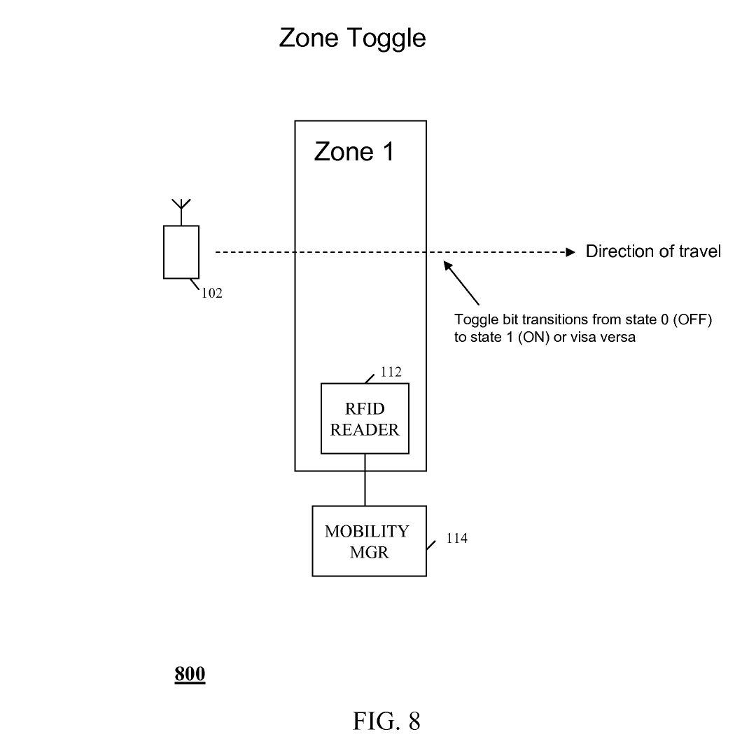

Referring now to FIGS. 8-10, further exemplary embodiments are provided of a detection of a presence of an MS, such as MS 102, and a corresponding RFID-based alteration of a behavior of the MS by communication system 100. FIG. 8 is a block diagram 800 illustrating a detection of a direction of movement and an alteration of a behavior of MS 102 by communication system 100 in accordance with a ‘single’ zone embodiment of the present invention. As depicted in block diagram 800, communication system 100 comprises an RFID coverage area or zone, that is, Zone 1. Zone 1 may be situated at an entrance to an enclosed area, such as a building or a section of a building, and is serviced by RFID reader 112; however, one of ordinary skill in the art realizes that the enclosed area may have several points of egress and ingress and that an RFID reader, such as RFID reader 112, may be located at each such point. In such an event, the functionality described herein with respect to RFID reader 112 may be distributed among one or more other such RFID readers.

Before entering Zone 1, a predetermined bit maintained in the memory of RFID tag 104 of MS 102, which tag 104 is a write-able tag, is set to a predetermined value, such as ‘0.’ When MS 102 enters Zone 1, RFID tag 104 of MS 102 is detected by RFID reader 112. RFID reader 112 causes RFID tag 104 to activate and the activated RFID tag transmits RFID information, including the identifier of MS 102 and the current setting of the predetermined bit, that is, the value ‘0,’ to RFID reader 112. RFID reader 112 then forwards the MS identifier and received bit to mobility manager 114.

Based on the value of the received bit, that is, the value ‘0,’ mobility manager 114 determines that MS 102 is entering the enclosed area. Mobility manager 114 further instructs RFID reader 112 to flip the predetermined bit, that is, to flip the ‘0’ to a ‘1.’ In response to the instruction, RFID reader 112 instructs RFID tag 104 to flip the predetermined bit to a ‘1,’ and accordingly the RFID tag writes a ‘1’ over the ‘0.’ A value of ‘1’ corresponds to the RFID tag being in the enclosed area. Further, in response to determining that MS 102 is entering the enclosed area, RFID tag reader 110, and in particular mobility manager 114, may arrange for an enablement, disablement, or modification of services provided to, or functionality of, MS 102 by service provider network 150 as is described above in greater detail.

When MS 102 subsequently leaves the enclosed area, the MS again passes through Zone 1. When MS 102 re-enters Zone 1, RFID tag 104 of MS 102 is again detected by RFID reader 112 and the RFID reader 112 causes RFID tag 104 to activate. Activated RFID tag 104 transmits RFID information including the identifier of MS 102, along with the current setting of the predetermined bit, that is, the value ‘1,’ to RFID reader 112 and the RFID reader 112 forwards the MS identifier and received bit to mobility manager 114. Based on the value of the received bit, that is, the value ‘1,’ mobility manager 114 determines that MS 102 is leaving the enclosed area. Mobility manager 114 further instructs RFID reader 112 to again flip the predetermined bit, that is, to flip the ‘1’ to a ‘0.’ In response to the instruction, RFID reader 112 instructs RFID tag 104 to flip the predetermined bit to a ‘0,’ and accordingly the RFID tag writes a ‘0’ over the ‘1.’ A value of ‘0’ corresponds to the RFID tag being outside the enclosed area. Further, in response to determining that MS 102 is leaving the enclosed area, RFID tag reader 110, and in particular mobility manager 114, may arrange for a reversal, by service provider network 150, of the enablement, disablement, or modification of services or functions performed when the MS entered the enclosed area.

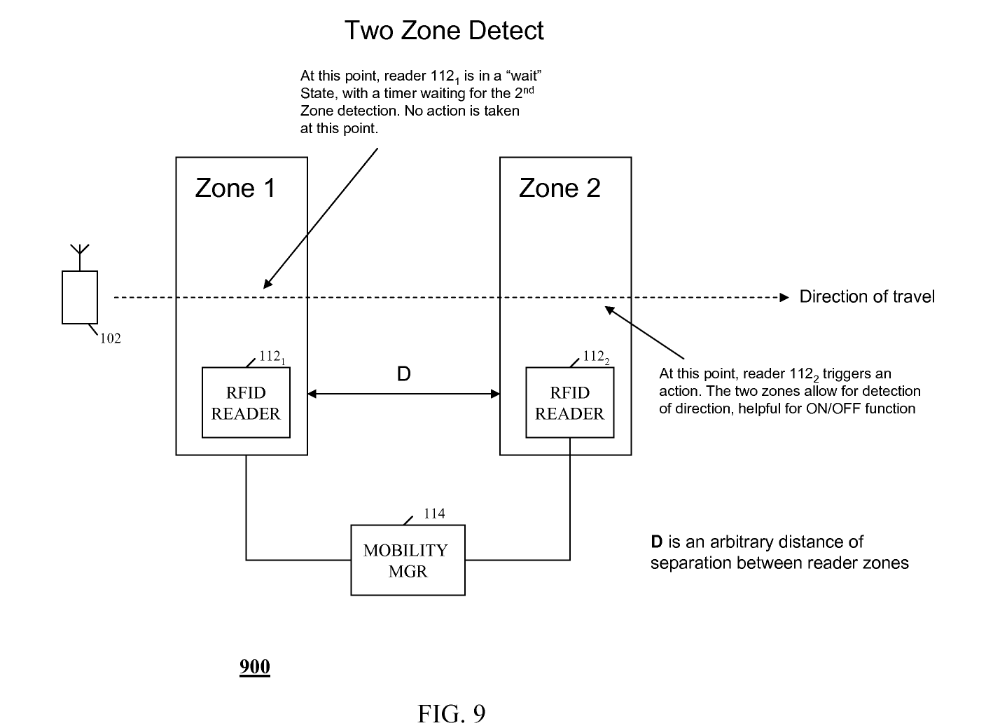

FIG. 9 is a block diagram 900 illustrating a detection of a direction of movement and an alteration of a behavior of MS 102 by communication system 100 in accordance with a ‘multiple zone’ embodiment of the present invention. As depicted in block diagram 900, communication system 100 comprises two RFID coverage areas, or zones, that is, a first zone, Zone 1, and a second zone, Zone 2. The two zones are separated by an arbitrary distance D, which distance may be as small as zero (the two zones may be adjacent). RFID tag reader 110 comprises two RFID readers, that is, a first RFID reader 112₁ and a second RFID reader 112₂, that are each coupled to mobility manager 114. Zone 1 is serviced by RFID reader 112₁ and Zone 2 is serviced by RFID reader 112₂.

MS 102, and more particularly RFID tag 104, is first detected by RFID reader 112₁, when the MS is present in Zone 1. RFID reader 112₁ causes RFID tag 104 to activate and the activated tag transmits RFID information, including the identifier of MS 102, to RFID reader 112₁. RFID reader 112₁ then forwards the MS identifier received from MS 102, along with an identifier of RFID reader 112₁, to mobility manager 114. Mobility manager 114 stores, in the one or more memory devices 304 of RFID tag reader 110, the MS identifier in association with the RFID reader 112₁ identifier.

MS 102 then roams to Zone 2, where RFID tag 104 is detected by RFID reader 112₂. RFID reader 112₂ causes RFID tag 104 to activate and the activated tag transmits RFID information, including the MS identifier, to RFID reader 112₂. RFID reader 112₂ then forwards the MS identifier received from MS 102, along with an identifier of RFID reader 112₂, to mobility manager 114. Based on the detection of MS 102 first by RFID reader 112₁ and then by RFID reader 112₂, mobility manager 114 determines a direction of travel of the MS. Based on the determined direction of travel, RFID tag reader 110, and in particular mobility manager 114, may arrange for an enablement, disablement, or modification of services provided to, or functionality of, MS 102 by service provider network 150 as is described above in greater detail.

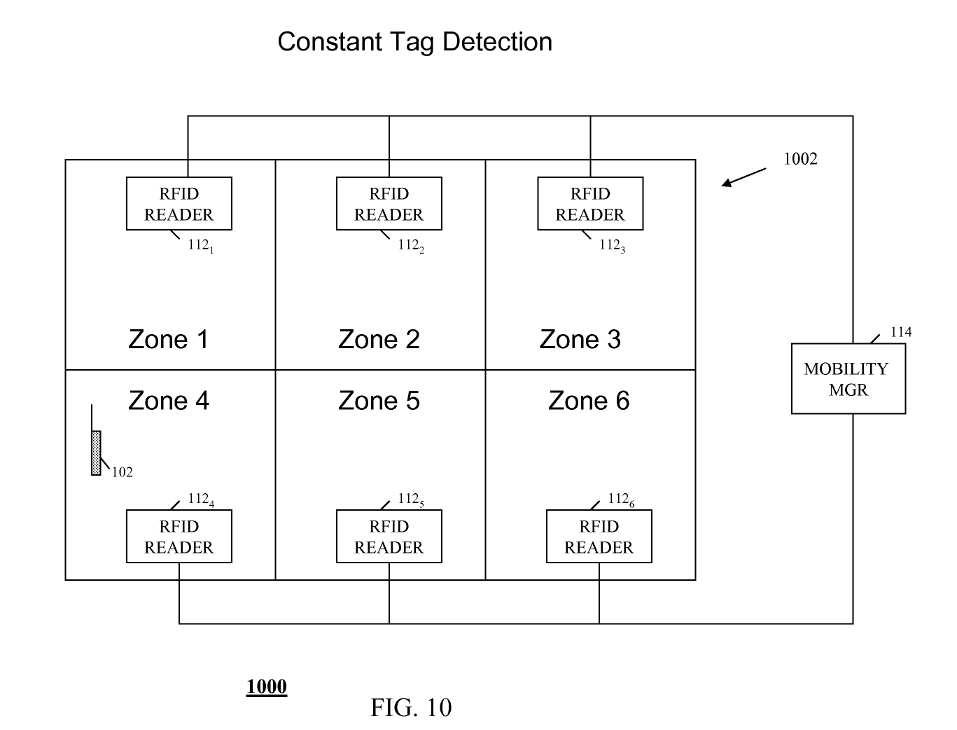

FIG. 10 is a block diagram 1000 illustrating a detection of MS 102 and an alteration of a behavior of the MS by communication system 100 in accordance with a ‘constant detection’ embodiment of the present invention. As depicted in block diagram 1000, RFID tag reader 110 comprises multiple RFID readers 112₁-112₆ that are each coupled to mobility manager 114. Further, communication system 100 comprises a geographic coverage area 1002, which coverage area comprises multiple RFID coverage areas, or zones, that is, Zones 1-6. Each of Zones 1-6 is serviced by a respective RFID reader 112₁-112₆.

When MS 102, and more particularly RFID tag 104, first enters coverage area 1002, for example, enters Zone 1, the MS, that is, RFID tag 104, is detected by an RFID reader servicing the entered zone, that is, RFID reader 112₁. RFID reader 112₁ causes RFID tag 104 to activate and the activated tag transmits the identifier of MS 102 to RFID reader 112₁. RFID reader 112₁ then forwards the MS identifier received from MS 102 to mobility manager 114 and the mobility manager arranges for an enablement, disablement, or modification of services provided to, or functionality of, MS 102, by service provider network 150 as is described above in greater detail, based on the MS being detected in coverage area 1002.

After detecting MS 102, mobility manager 114 further arranges for a continued detection of RFID tag 104 in coverage area 1002. That is, mobility manager 114 instructs RFID readers 112₁-112₆ to intermittently cause an activation of RFID tag 104, for example, to perform a ‘keep alive’ pinging of the RFID tag, in order to detect the presence of the RFID tag, and correspondingly MS 102, in coverage area 1002. In response to each ping, RFID tag 104 activates and conveys RFID information to the serving RFID reader, and via the RFID reader to mobility manager 114. When RFID tag 104 fails to respond for a predetermined successive number of pings, for example, for one or more successive pings, or fails to communicate with mobility manager 114 for a second time period that the mobility manager determines with reference to timer 120, the mobility manager determines that RFID tag 104, and correspondingly MS 102, has left coverage area 1002. In response to determining that RFID tag 104 has left coverage area 1002, RFID tag reader 110, and in particular mobility manager 114, may arrange for a reversal, by service provider network 150, of the enablement, disablement, or modification of services or functions performed when MS 102 was detected in coverage area 1002.

By enabling, disabling, or otherwise modifying a restricted service or functionality associated with an MS when an RFID tag of the MS is detected by an RFID network, and in particular by an RFID tag reader of the RFID network, communication system 100 is able to selectively, and on an MS-by-MS basis, alter a behavior of the MS when the MS is present in or proximate to a controlled area without first requiring that the MS be powered up or in direct communication with a service provider network subscribed to by the MS and without requiring a voluntary cooperation of a user of the MS. However, communication system 100 further provides for a notification of a user of the MS that the restricted service or functionality has been disabled, enabled, or otherwise modified. Further, communication system 100 may determine a direction of movement of the MS or a constant presence of the MS in the controlled area based on a detection of the RFID tag of the MS by the RFID network, thereby further enhancing and fine tuning the control exercised by the communication system over the restricted service or functionality in the controlled area. Communication system 100 further provides for a timer-based disablement or modification of the restricted service or function, thereby permitting a restoration of any disabled or modified functionality in the event that the communication system fails to detect an exit of the MS from the controlled area.

The service provider network is further able to preserve service provider resources by reducing services provided to, and requested of, the MS, such as paging services and presence updates, based on the RFID detection. By utilizing RFID detection, the service provider network is able to avoid utilizing service provider network resources in order to determine whether to reduce a provision of a service to the MS. In addition, by detecting a low charge condition of an MS based on the RFID tag detection, communication system 100 is able to minimize a power subsequently consumed by the MS, for example, by not speculatively waking up an MS or by not setting up of a traffic channel in air interface of the service provider's network in anticipation of an origination of call by the MS or in anticipation of an acceptance of a call by a target MS.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. The terms “including” and/or “having,” as used herein, are defined as comprising. The term “coupled,” as used herein, is defined as connected, although not necessarily directly, and not necessarily mechanically. An element preceded by “ . . . a” does not, without more constraints, preclude the existence of additional identical elements in the process, method, article, or apparatus that the element. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for altering a behavior of a mobile station comprising:
detecting a Radio Frequency Identification (RFID) tag associated with the mobile station; and
altering a behavior of the mobile station based on the detection of the RFID tag.

2. The method of claim 1, wherein detecting a Radio Frequency Identification (RFID) tag comprises detecting an identifier of the mobile station and one or more of a service and a mobile station function to be altered with respect to the mobile station.

3. The method of claim 2, wherein the method further determining a routing address of a service provider network associated with the mobile station and wherein altering comprises altering, by the service provider network, the one or more of a service and a mobile station function.

4. The method of claim 1, wherein detecting a Radio Frequency Identification (RFID) tag comprises detecting a mobile station identifier and a routing address of a service provider network associated with the mobile station and wherein altering comprises altering, by the service provider network, one or more of a service and a mobile station function.

5. The method of claim 1, wherein detecting comprises detecting, by a Radio Frequency Identification (RFID) reader, an RFID tag associated with the mobile station and wherein altering comprises altering, via a radio access network, one or more of a service provided to the mobile station and a function of the mobile station.

6. The method of claim 5, further comprising determining, by the RFID reader, a service code associated with one or more of a service or a mobile station function to be altered.

7. The method of claim 6, wherein detecting a Radio Frequency Identification tag comprises detecting an identifier of the mobile station, wherein the method further comprises determining, based on the mobile station identifier, a routing address of a service provider network associated with the mobile station, and wherein altering comprises altering, by the service provider network and via the radio access network, the one or more of a service and a mobile station function.

8. The method of claim 5, wherein altering comprises altering paging information associated with the mobile station.

9. The method of claim 1, wherein altering comprises updating presence information associated with the mobile station.

10. The method of claim 9, further comprising writing updated presence information to the Radio Frequency Identification tag.

11. The method of claim 1, wherein detecting a Radio Frequency Identification tag comprises detecting a mobile station identifier and a charge level associated with a power source of the mobile station and wherein altering comprises altering a service provided to the mobile station based on the detected charge level.

12. The method of claim 1, wherein detecting comprises detecting a plurality of Radio Frequency Identification tags associated with a plurality of mobile stations residing in a controlled area and wherein altering comprises altering a behavior of a mobile station of the plurality of mobile stations and not altering a behavior of another mobile station of the plurality of mobile stations.

13. The method of claim 1, further comprising notifying a user of the mobile station of the altered behavior.

14. A wireless communication system comprising:
a Radio Frequency Identification (RFID) network that detects an RFID tag associated with a mobile station; and
a service provider network coupled to the RFID network that alters a behavior of the mobile station based on the detection of the RFID tag by the RFID network.

15. The communication system of claim 14, wherein the Radio Frequency Identification (RFID) network comprises an RFID reader that detects an RFID tag comprising an identifier of the mobile station and one or more of a service and a mobile station function to be altered with respect to the mobile station.

16. The communication system of claim 15, wherein the Radio Frequency Identification (RFID) network further determines a routing address of a service provider network associated with the mobile station and wherein the service provider network alters a behavior of the mobile station by altering the one or more of a service and a mobile station function.

17. The communication system of claim 14, wherein the Radio Frequency Identification (RFID) network comprises an RFID reader that detects an RFID tag comprising a mobile station identifier and a routing address of a service provider network associated with the mobile station and wherein the service provider network alters a behavior of the mobile station by altering one or more of a service and a mobile station function.

18. The communication system of claim 14, wherein the Radio Frequency Identification (RFID) network comprises an RFID reader that detects an RFID tag associated with the mobile station and wherein the service provider network comprises a radio access network that alters one or more of a service provided to the mobile station and a function of the mobile station.

19. The communication system of claim 18, wherein the Radio Frequency Identification reader detects a service code associated with one or more of a service or a mobile station function to be altered.

20. The communication system of claim 19, wherein the Radio Frequency Identification (RFID) reader detects an identifier of the mobile station, wherein the RFID network determines, based on the mobile station identifier, a routing address of the service provider network.

21. The communication system of claim 18, wherein the service provider network alters a behavior of the mobile station by altering paging information associated with the mobile station.

22. The communication system of claim 14, wherein the service provider network alters a behavior of the mobile station by updating presence information associated with the mobile station.

23. The communication system of claim 22, wherein the service provider network further writes updated presence information to the Radio Frequency Identification (RFID) tag via the RFID network.

24. The communication system of claim 14, wherein detecting a Radio Frequency Identification tag comprises detecting a mobile station identifier and a charge level associated with a power source of the mobile station and wherein altering comprises altering a service provided to the mobile station based on the detected charge level.

25. The communication system of claim 14, wherein the Radio Frequency Identification (RFID) network comprises an RFID reader that detects a plurality of RFID tags associated with a plurality of mobile stations residing in a controlled area and wherein the service provider network alters a behavior of a mobile station of the plurality of mobile stations and does not alter a behavior of another mobile station of the plurality of mobile stations.

26. The communication system of claim 14, further comprising the mobile station and wherein the mobile station notifies a user of the mobile station of the altered behavior.
